(19) United States
(12) Patent Application Publication
(10) Pub. No.: US 2024/0198367 A1
(43) Pub. Date: Jun. 20, 2024

(54) LIQUID CANNON

(71) Applicant: Clean Plant Pty Ltd, Bedford, Western Australia (AU)

(72) Inventor: Braydon Munro, Bedford, Western Australia (AU)

(21) Appl. No.: 18/557,145

(22) PCT Filed: Apr. 26, 2022
(86) PCT No.: PCT/AU2022/050383

§ 371 Date: Oct. 25, 2023

(30) Foreign Application Priority Data
Apr. 27, 2021 (AU) 2021901243

(51) Int. Cl. B05B 3/12; B05B 15/652

(52) U.S. Cl. CPC B05B 3/12; B05B 15/652

(57) ABSTRACT

A liquid cannon for use in discharging a liquid. The liquid cannon has an inlet for the liquid and a conduit providing a flowpath for the liquid between the inlet and at least one nozzle. The liquid cannon includes a head assembly having a turret supporting the at least one nozzle. The conduit passes through a bearing rotationally supporting the turret relative to a mount.

### TECHNICAL FIELD

The present invention relates to a liquid cannon for directing a stream of liquid.

One or more non-limiting applications of the present invention provides a liquid cannon for use in harsh or hazardous environments, such as mining and mineral conveying applications, quarrying, mineral extraction, fire-fighting, rigs and offshore applications.

One or more non-limiting applications of the present invention provides a liquid cannon for use with fixed or mobile material processing equipment (e.g. a transfer chute, a ball mill etc.). One or more non-limiting applications of the present invention provides a liquid cannon for use with bulk material transport equipment. The bulk material transport equipment may be associated with methods such as bulk carrier shipping, rail or road haulage. One or more non-limiting applications of the present invention provides a liquid cannon for use with the cleaning of heavy industry equipment, such as surface mining equipment. One or more non-limiting applications of the present invention provides a liquid cannon for use in industrial cleaning applications involving water or hazardous liquids. One or more non-limiting applications of the present invention provides a liquid cannon for use in hydraulic mining or hydraulic surface conditioning.

One or more non-limiting applications of the present invention provides a liquid cannon for directing water to dislodge material from a surface.

A particular application of the present invention provides a liquid cannon for facilitating removal of bulk material (e.g. ore, minerals or other pulverulent materials, coal, grain etc.) from a transfer chute (such as associated with a conveyor system).

It will be appreciated that the liquid cannon can direct a jet/spray of water (such as for cleaning surfaces, removing materials such as blockages or detritus, damping surfaces/stockpiles, or washing minerals from deposits/stacks), foam (such as for fire-fighting), water with entrained other liquid(s) and/or particulates (such as a scouring/blasting material for removal of material from a surface or for abrading/texturizing the surface.

### BACKGROUND TO THE INVENTION

Whilst the following background relates to facilitating removal of material from transfer chutes associated with bulk material handling operations/installations, it will be appreciated that the present invention can be provided for use in other applications where material removal from a surface is required, particularly bulk materials.

Transfer chutes within the bulk material handling industry regularly require cleaning to remove blockages, particularly at bottleneck points in material transfer installations, and for undertaking maintenance activities. Blockages prevent or restrict flow of the bulk material and disrupt production processes, resulting in delays, lost productivity and increased production costs.

Cleaning can involve the removal of tonnes of bulk material retained within the transfer chute over time. Cleaning is known to be typically performed by process plant operators with hoses spraying water from outside of the chute via one or more access windows. To comply with safety and risk management procedures, safety protocols must be followed to protect personnel accessing the area to perform the cleaning activities. Such cleaning requires production from the process plant to cease, often resulting in several hours of lost revenue.

Major shutdowns are a regular occurrence at industrial sites, and require the cleaning of many transfer chutes within the same period and represent significant periods of lost production and cleaning costs in terms of man-hours/cleaning personnel

Reducing the time required to effectively clean bulk material transfer chutes has the potential to improve the utilisation of mineral process plants (reduced disruption and down-time) and in return provide higher revenues and financial performance.

Severe dust, heat, humidity, vibration and restricted space create an extremely harsh environment within a bulk material transfer chute.

Removing, or at least reducing, the need for personnel to conduct cleaning/unblocking of such transfer chutes or other pinch-points/bottlenecks, such as in bulk material handling operations, can increase safety and reduce economic loss.

Typically range of motion of a liquid cannon is restricted in each axis due to the need for external flexible electrical cabling. Such cables are also exposed to the elements and susceptible to damage. It is desirable for a liquid cannon that provides both increased range of motion and reliability, such as through the elimination of the external flexible cables between each axis.

Specifically, in roof mounted applications such as firefighting, it is financially desirable to install a lesser number of cannon/turrets incorporating a higher range of motion compared to a greater number of water cannon requiring overlapping fields of view for the same space.

Reducing the packaging of water cannons is desirable as it reduces the head space required for a cannon to operate without obstructing the intended purpose of that space, this reduction in head space lowers the size of the space required, improving the capital efficiency of the space. It also improves the viability of implementing water cannons in existing spaces with limited head space.

The dominate failure mode of existing water cannons is damage or wear of the rotary union bearing which in turn causes failure of one or more seals. Damage or wear of the rotary union bearing is the result of the reaction force from discharge water or, when mounted to a mobile vehicle, the forces required to accelerate and decelerate the mass of the cannon. It is desirable that the primary load path for forces acting upon the cannon does not pass through the pipework rotary unions.

Another failure mode of liquid cannons is when process material affects the motion or function of the liquid cannon nozzle or the discharge liquid. Such affects can include but are not limited to corrosion, fatigue, bending, blockage, obstruction, deflection, abrasion or erosion of the nozzle. It is desirable that the liquid cannon protects, separates, or isolates process material from the nozzle of the liquid cannon by providing a physical barrier between the nozzle and the process material.

Liquid cannons interacting with process material can experience wear, degradation or malfunction over time. It is desirable that a liquid cannon incorporates geometry and material selection that minimise process material affects. It is also desirables that sections of the liquid cannon incorporate replaceable or serviceable features to prolong effective service life of liquid cannons.

The use of peripherals, such as sensing equipment, or variable stream nozzles is known for use with water cannons. Such peripherals are typically mounted by bracket to the cannon pipework, providing little protection of the peripheral or associated cabling. It is desirable that such peripherals are mounted internal of the liquid cannon body and thus protected from the environment. Such peripherals are often of significant value relative to the cost of the cannon itself. It is desirable that such peripherals components are protected or separated from the effects of process material by the liquid cannon whilst also maintaining an effective field of view. Aspects of liquid cannons may limit or obstruct a peripheral's field of view. It is desirable that the field of view of such peripherals is maximised and obstructions in the field of view associated to the liquid cannon itself are minimised.

With the aforementioned in mind, it has been found desirable to provide at least one alternative or additional apparatus, device, system and/or process that ameliorates at least one shortcoming of known cleaning installations and/or processes for cleaning at least bulk material transfer chute installations.

### SUMMARY OF THE INVENTION

With the aforementioned in mind, an aspect of the present invention provides a liquid cannon, for directing liquid for dislodging material, dispersing the material, or removal of the material from a surface.

Disclosed is a liquid cannon for use in discharging a liquid, the liquid cannon having an inlet for the liquid and a conduit providing a flowpath for the liquid between the inlet and a nozzle, and wherein the liquid cannon includes a head assembly having a turret supporting the nozzle, and wherein the conduit passes through a bearing rotationally supporting the turret relative to a mount.

The liquid cannon may be suitable for use in cleaning one or more of a transfer chute and bulk material transport equipment, such as equipment related to bulk carrier shipping, rail or road haulage. The liquid cannon may be suitable for use in cleaning heavy industry equipment, such as surface mining equipment. The liquid cannon may be suitable for use in industrial cleaning applications involving water or hazardous liquids. The liquid cannon may be suitable for use in hydraulic mining or hydraulic surface conditioning. The liquid cannon may be suitable for use in harsh or hazardous environments, such as mining and mineral conveying applications, quarrying, mineral extraction, fire-fighting, rigs and offshore applications.

The liquid cannon may include a controller and at least one drive means, the controller arranged and configured to control the at least one drive means to drive movement of the nozzle.

The turret may provide a protective cover or shell for components within the turret.

The nozzle may be mounted by at least one pivot connection wherein liquid to the nozzle flows through at least one said pivot connection.

A sleeve, preferably part of a tail assembly, may be configured to receive therein a portion of the conduit.

The turret and at least a portion of the conduit can be arranged and configured to rotate relative to the mount.

The inlet of the conduit may be fixedly connected to the mount or fixed installation, and a rotary coupling of the conduit permits rotation of the turret and at least a portion of the conduit relative to the fixed inlet.

A fixed portion of the conduit preferably connects to a rotary coupling connected to the inlet, and the fixed portion of the conduit connects to a rotary union permitting rotational motion of the nozzle.

Electrical, mechanical, pneumatic or hydraulic drive means may be provided to actuate luff rotation of the nozzle and/or slew rotation of the turret.

Slew rotation of the turret is preferably driven by an arrangement including a driven pinion gear engaging with a ring gear.

A rotary electrical connector preferably provides continuity of electrical connection between the turret and the mount.

A portion of the conduit may pass through the rotary electrical connection.

The head assembly may include at least one sensor housed therein. At least one sensor may include at least one of lidar, radar, thermal sensing, imaging, Doppler, GPS, rotational orientation of the turret and/or nozzle, or any combination of two or more thereof.

The nozzle is preferably mounted for luff rotation to the turret by bearing arrangement laterally positioned with respect to one side of the nozzle or is mounted for rotation by bearing arrangements laterally positioned with respect to either side of the nozzle.

A sleeve of a tail assembly receives therein a rotary coupling of the conduit, and a portion of the conduit attaches to the sleeve.

The liquid cannon may include a slew rotation bearing having a rotation axis concentric with an axis of the conduit passing through the mount.

Disclosed is a liquid cannon for use in cleaning material from a surface of a transfer chute, the liquid cannon having an inlet for water and a conduit providing a flowpath for the water between the inlet and the nozzle, and wherein the liquid cannon is mountable to the transfer chute such that a nozzle for outlet of the water from the liquid cannon is within an interior space of the transfer chute.

The conduit and/or the inlet may project through a portion, such as a wall, of the transfer chute. Such an arrangement allows the liquid cannon to be mounted to the transfer chute with an inlet or conduit connected to the nozzle such that a supply conduit to the nozzle does not need to be exposed within the interior space of the transfer chute.

A head assembly of the liquid cannon is locatable in the interior space of the transfer chute and a tail assembly locatable outside of the interior space of the transfer chute.

The head assembly may support at least one said nozzle with at least two degrees of freedom of movement of the at least one said nozzle. The at least two degrees of freedom may include rotation (e.g. yaw/slew) and elevation (e.g. pitch). Taking straight-ahead or horizontal or perpendicular to a stem or tail assembly of the cannon as a 0° reference, the nozzle may angle below 0° (such as to −5° or −10° or −20° or −30), and the nozzle may rotate upward to and preferably beyond vertical (straight-upward from the cannon body i.e. coaxial with the stem/tail assembly). The nozzle may rotate relative to the body such that the nozzle points rearward of the body, and preferably is able to point at a depression angle of up to −20° rearward of the body. Overall, the angle of rotation from forward depression through forward, through elevated, past vertical, to rearward and preferably rearward depression angle can be 240°, preferably up to 220°.

The liquid cannon may include a controller and at least one drive means. The at least one drive means may include one or more actuators, such as electric, hydraulic or pneumatic actuators, which may include one or more rotary actuators. The controller may be arranged and configured to control the at least one drive means to drive movement of the nozzle.

The liquid cannon may include an outer protective cover or shell for components within the head assembly. The protective cover/shell may include or be formed of a polymer, metal, carbon composite, fibreglass/GRP, or a combination of two or more thereof. The metal may preferably include steel, aluminium, or a metal alloy.

The nozzle may be mounted by at least one pivot connection including a first pivot connection and a second pivot connection, the first and the second pivot connections being axially aligned. Mounting of the nozzle may be a ‘T’ arrangement with pivot connections either side of the nozzle. The water to the nozzle may flow through at least one said pivot connection.

The liquid cannon may include a mount for attachment to the portion of the transfer chute, and the head assembly is attached to the mount. The conduit may pass through the mount.

The mount may include a mounting plate and a sleeve, wherein the sleeve is configured to receive therein a portion of the conduit.

The head assembly and at least a portion of the conduit may be arranged and configured to rotate relative to the mount.

The inlet to the conduit may be fixedly attached to the mount and a rotary coupling of the conduit permits rotation of the head assembly and at least a portion of the conduit relative to the fixed inlet.

It will be appreciated that one or more forms of the present invention may provide a cleaning device, such as a liquid cannon, installed into a conveyor transfer chute for the purpose of dislodging material from within bulk material transfer chutes by a stream of directed water from the device.

An aspect the present invention provides a device for use within an interior space of a bulk material transfer chute for the purpose of removing material using a directed stream of water.

One or more embodiments may include a liquid cannon turret, optionally including a protective external cover, shell or casing.

When installed, a head assembly locates within the bulk material transfer chute whilst a tail assembly protrudes outside the transfer chute.

One or more embodiments may include an electrical slip ring and/or a rotary union.

Internal plumbing and rotary unions may provide for the passage of water from the inlet, such as of the tail assembly, to a discharge port in the head assembly, such as of the nozzle.

Preferably, the liquid cannon/device prioritises compactness to reduce obstruction of the material flow path via the incorporation of a head assembly located dominantly inside the transfer chute and tail section protruding external of the chute.

The tail assembly of the cannon/device may be attached/fixed to a bulk material transfer chute at a mating plane.

Directing the stream of water in the yaw/slew axis may be achieved by rotation of the head assembly relative to the tail assembly.

Rotational drive of the head assembly may be provided by a pinion and gear mechanism.

A fixed gear may be provided on the mount/tail assembly and a driven pinion gear may be present in the head assembly.

A worm gear box may be provided between the driven pinion gear and a drive actuator/motor.

The worm gear box may be driven by a servo drive motor.

The head assembly comprises a nozzle/discharge port that is able to rotate in a second axis of rotation independent to an axis of rotation between the head and mount/tail assembly. The second degree of freedom may be perpendicular to the first degree of freedom. The second axis of rotation need not intersect the first axis of rotation.

The second axis of rotation may be inline/coaxial with or offset from the first rotation of axis.

Rotation about the second axis of rotation may be driven by an electro-mechanical drive system.

A rotary union may be present in plumping, such as aligned with the first axis of rotation permitting rotary motion.

A second rotary union may be present in head section plumping aligned with the second axis of rotation.

An electrical slip ring may be present in the tail section. The electrical slip ring may include a through-hole configuration and may encompass plumbing/conduit.

Electrical cabling, data cabling and/or water/liquid supply to the nozzle can be provided coaxial with a slew/rotation axis of the turret/dead. It will be appreciated that cabling and/or conduit coaxial with the slew/rotation axis allows the turret to rotate through 360°. Electrical supply and/or data can be provided through an arrangement of one or more slip ring connections.

At least one sensor may be provided for sensing the angular position of the head assembly relative to the mount/tail assembly. Such sensing may include at least one sensor for sensing the angular position of the second axis relative to the head assembly.

One or more forms of the present invention finds application in delivering a caustic liquid, such as used in chemical process plant/installation cleaning.

It has been realised that protecting internal components of the liquid cannon, such as wiring, electronics and plastic/polymer components, from external heat is beneficial.

The liquid cannon may include a heat resistant or flame-retardant turret/body or have a cover/shell providing heat resistance/flame retardancy.

Internal space within the body/turret may provide space for at least one cooling arrangement, such as one or more thermal cooling devices or systems, e.g. cooling jackets or tubing or heatsink, or combinations thereof, such as to protect the internal components of the liquid cannon.

Insulating materials may be provided internally or externally, or both, of the body/turret. The turret/body may include heat insulating materials. Such insulating materials may include thermal lagging material.

The liquid cannon according to one or more embodiments of the present invention may find use in fire/heat resistant applications, heavy vehicle detergent cleaning agents (acid often used to remove iron oxide staining from haul trucks/SME), applying leach agents to ores (which agents can be corrosive), applying anti-dust ground treatments on mine sites, applying caustic (process tank cleaning), foam spray (e.g. for fire-fighting), hydraulic mining/sluicing (clays, tin, uranium, gold, coal, slurry retrieval, etc.), tailings discharge to spray tailings entrained in the liquid to dry/semi-dry through spraying and optionally sweeping the cannon nozzle left to right, fire-fighting, ore sorting, shotcrete application, remote sand blasting (flash back fragile components), remote concrete cutting (flash back hits fragile components).

The liquid cannon may be provided as one or more of mobile vehicle mounted (such as on a tracked or wheeled chassis or trailer or skid steer arrangement), may traverse a linear rail or gantry system, may hang suspended e.g. from the hook of a crane, may be mounted to a transportable mount e.g. concrete block (gravity block), may be mounted to the boom e.g. of a jumbo/excavator type machine.

The turret can rotate 360° with respect to the tail assembly/fixed mount. The nozzle can rotate (luff) from a forward downward elevation (forward depression) through an arc to a rearward downward elevation (rearward depression), preferably through up to or more than 200° of arc.

It will be appreciated that one or more forms of the present invention may be, or may be included or incorporated into, one or more of the following products: a spray solution (such as in an aerosol or pump spray), a concentrate for subsequent dilution prior to use, a ready to use solution, a solid product for dispersal in a solution, a solid product for inclusion in packaging or a transport container with the processed or pre-processing raw or cooked or partly cooked animal or plant product.

A force, when applied to the head assembly of the liquid cannon, can transfer to the tail assembly of the liquid cannon and in turn to the structure the liquid cannon is mounted too. These forces may be the result of impact from a foreign object, reaction force from the discharge of liquid and/or the dynamic acceleration of the head when mounted to a moving vehicle.

Passing of such force from the head assembly to the tail assembly can include the passing of the force through a rolling element bearing.

Assuming both the slew (rotation) bearing (turret/head to tail rotation bearing) and rotary union (allowing rotation of the internal conduit of the turret to the fixed inlet portion of the conduit) have similar tolerances, the larger diameter of the slew bearing provides a moment arm relative than the rolling elements of the rotary union and thus will form the primary load path between the head and tail assembly.

Passing of a force from the luff elbow (rotatable conduit portion) to the head assembly must pass through a rolling element bearing.

Assuming both the luff bearing(s) and rotary union have similar tolerances, the larger diameter of the luff bearing(s) provides a moment arm relative than the rolling elements of the rotary union and thus will form the primary load path between the luff elbow and head assembly.

Furthermore, there may be more than one bearing supporting the luff elbow (rotatable conduit portion) of the head assembly/turret, such as when more than one bearing supports the axis in a double-ended configuration. The distance between the two concentric bearings provides a secondary moment arm for the transfer of force separate to that of the rotary union.

The liquid cannon may include a compartment within the head assembly. The compartment can accommodate sensing equipment, such as for environmental conditions, turret/nozzle positioning, targeting the liquid discharge. The sensing equipment can comprise one or more sensors. The one or more sensors can include a camera, a lidar sensor, a radar sensor, a thermal imaging sensor, an acoustic sensor and/or a sensor utilising the electromagnetic spectrum. Such sensors and/or the sensing provided by such sensors can be provided to assist in the control of the turret, guide/inform a liquid cannon/turret operator and/or to understand the environment within which the liquid cannon/turret is operated.

A reaction force applied to the head assembly of the liquid cannon when discharging liquid can transfer to the tail assembly of the liquid cannon in turn to the structure it is mounted to.

The turret ring (or slew bearing) preferably provides a primary load path for forces that act upon the head assembly to the tail assembly and in turn the structure (such as a wall, chute, pedestal, bracket etc.) to which the liquid cannon is fixed too. Such an arrangement removes the primary load path away from the rotary union.

These forces may be the result of impact from a foreign object, reaction force from the discharge of liquid or the dynamic acceleration of the head when mounted to a moving vehicle.

Passing of this force from the head to the tail involves the passing of the force through a bearing, such as a rolling element bearing. Assuming both the slew bearing and rotary union have similar tolerances, the larger diameter of the slew bearing provides a moment arm relative than the rolling elements of the rotary union and thus will form the primary load path between the head and tail assembly. Passing of a force from the luff elbow to the head assembly can involve passing of the force through the bearing. Assuming both the luff bearings and rotary union have similar tolerances, the larger diameter of the luff bearing provides a moment arm relative than the rolling elements of the rotary union and thus will form the primary load path between the luff elbow and head assembly.

Furthermore, there may be more than one bearing supporting the luff elbow, when more than one bearing support the axis. The distance between the two concentric bearings provides a secondary moment arm for the transfer of force separate to that of the rotary union.

### BRIEF DESCRIPTION OF THE FIGURES

One or more embodiments or examples of the present invention will hereinafter be described with reference to the accompanying Figures, in which:

FIG. 1A is a perspective view of an embodiment of the present invention.

FIG. 1B is a front view illustrating an embodiment of the present invention including a turret on a mount attached at a mounting plane.

FIGS. 2A to 2C show exploded side, lower front perspective and upper front perspective views illustrating an embodiment of the present invention including a turret and mount.

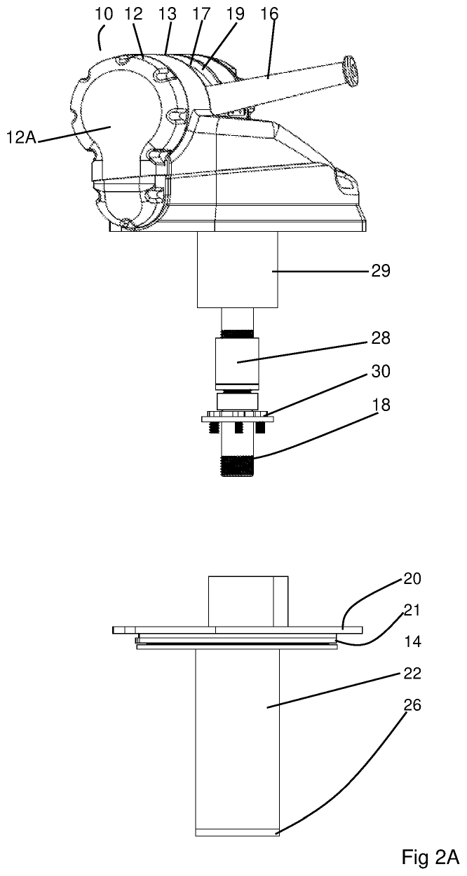

FIGS. 3A and 3B show perspective and front views of an alternative liquid cannon according to a further embodiment of the present invention.

FIGS. 4A and 4B show front and side internal views of a liquid cannon according to an embodiment of the present invention.

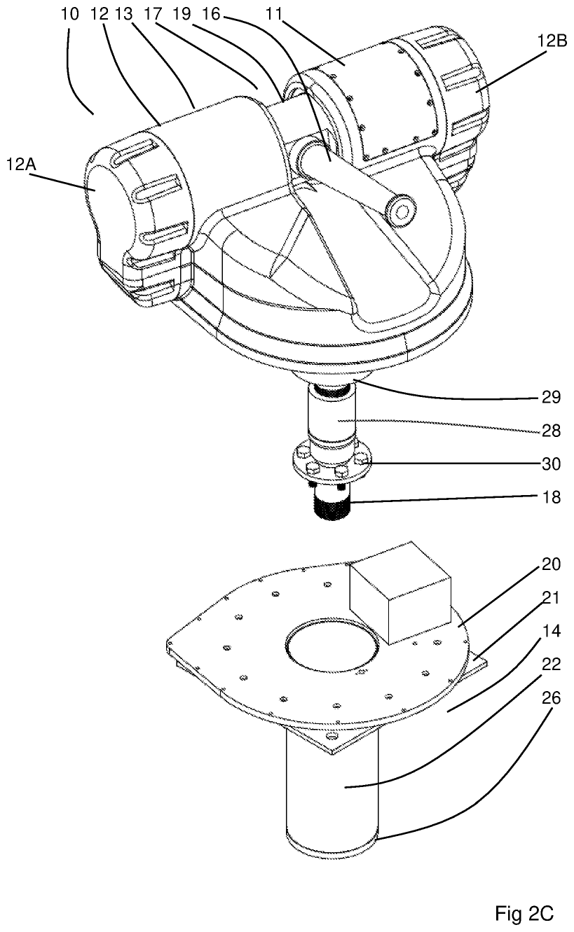

FIG. 4C is a detail perspective view of a mount/tail assembly for receiving the head assembly according to an embodiment of the present invention.

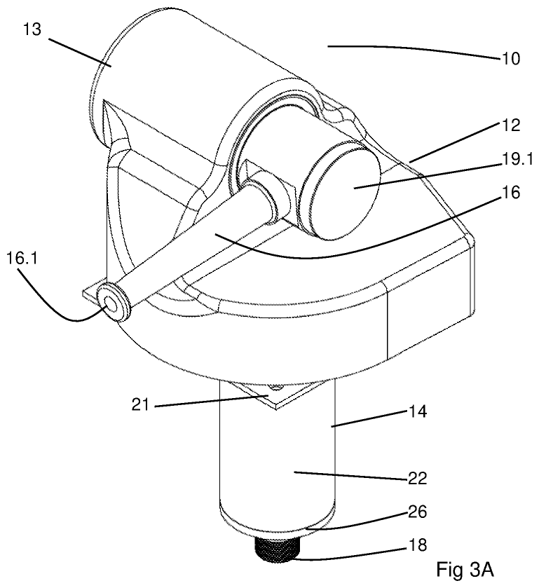

FIG. 5 is a side view of a liquid cannon according to an embodiment of the present invention providing a representation of an overall luff angle for the nozzle.

FIG. 6 is a side cross-sectional view of an illustrative bulk material transfer chute incorporating an embodiment of the present invention.

FIGS. 7a, 7b and 7c show respective perspective, front and side views of a pedestal mounted liquid cannon according to an embodiment of the present invention.

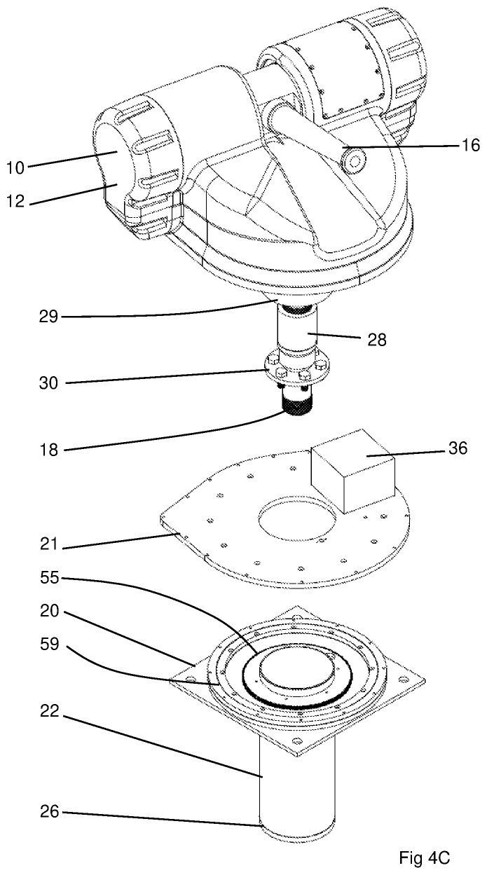

FIG. 8 shows an alternative pedestal mounted embodiment of the liquid cannon.

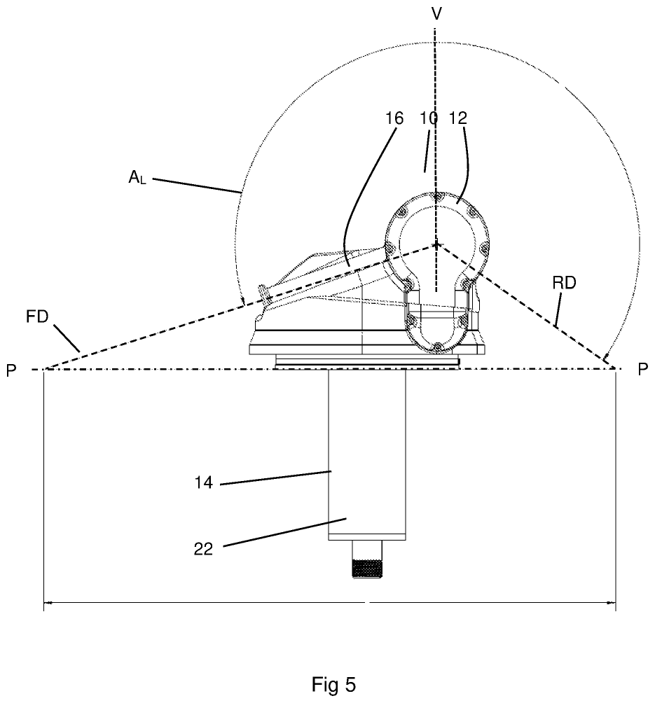

FIGS. 9a to 9b show bracket mount arrangements of the liquid cannon according to a further embodiment of the present invention.

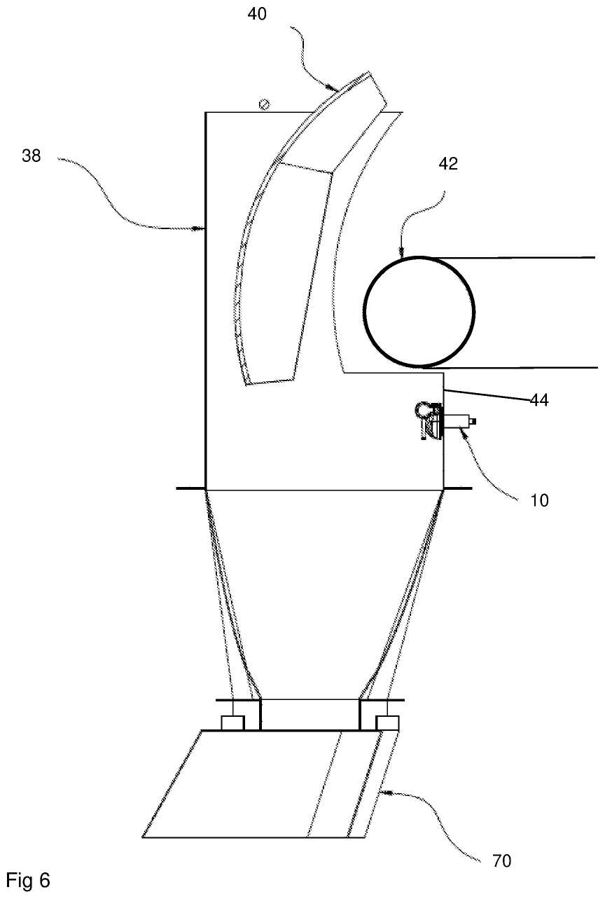

FIG. 10 shows a liquid cannon pre-mounted to an adapter plate, with the head assembly of the liquid cannon configured to pass through an aperture in a wall and the adapter plate to mount to the wall, according to a further embodiment of the present invention.

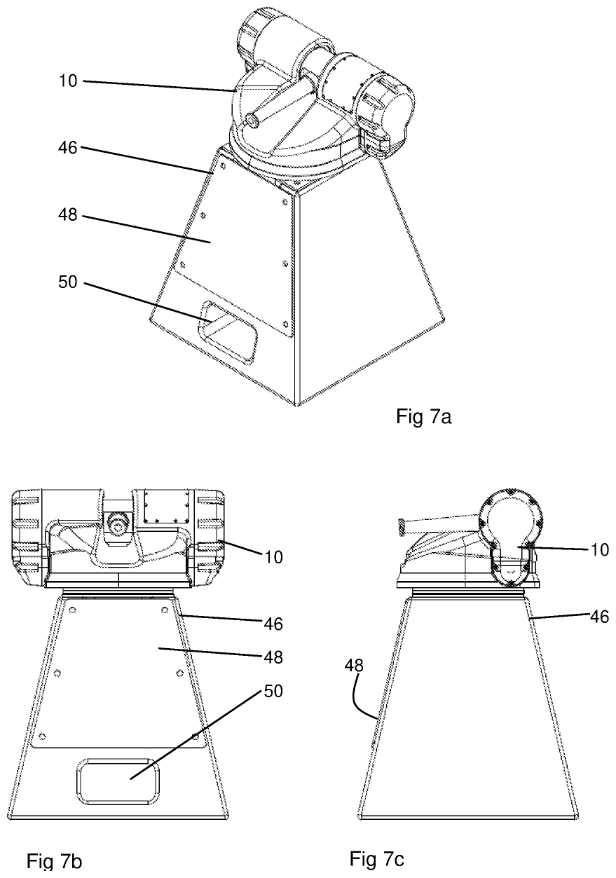

FIGS. 11A and 11B show an example of reaction forces conveyed through the rotatable conduit portion and the turret/head assembly bearing according to an embodiment of the present invention.

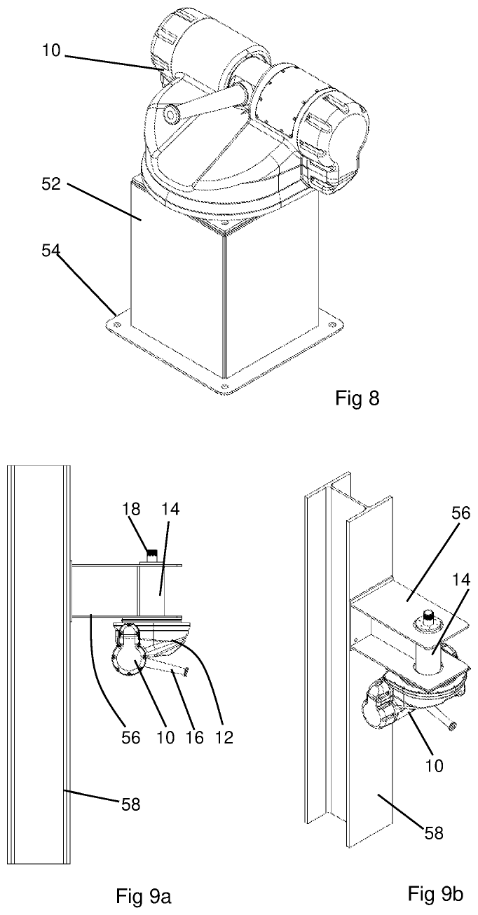

FIGS. 12A and 12B show an alternative liquid cannon including multiple nozzles according to a further embodiment of the present invention.

FIG. 13 is a side view of an embodiment a liquid cannon illustrating a trajectory of process material from the liquid cannon, according to some embodiments.

FIG. 14A is a perspective view of another embodiment of a liquid cannon, including a shell and a surface liner, according to some embodiments.

FIG. 14B is another perspective view of the liquid cannon of FIG. 14A, according to some embodiments.

FIG. 14C is a perspective view of the liquid cannon of FIG. 14A shown in an exploded state with the surface liner disconnected from a first shell portion.

### DESCRIPTION OF PREFERRED EMBODIMENT(S)

It will be convenient to further describe the invention with reference to preferred embodiments of the present invention. Other embodiments are possible, and consequently the particularity of the following discussion is not to be understood as superseding the generality of the preceding description of the invention.

Referring to the Figures, there is liquid cannon 10 including a head assembly 12 which is arranged to rotate relative to a mount or tail assembly 14. The liquid cannon 10 may be referred to as a turret. The liquid cannon 10 may be referred to as a fluid cannon. The liquid cannon 10 is configured to expel a fluid (e.g. a liquid such as water, a foam, a gas etc.).

The head assembly 12 can include a body 13 and end caps 12A, 12B.

Mounted within the head end assembly 12 is a nozzle 16 to discharge the fluid. In some embodiments, the fluid may be water. The liquid cannon 10 comprises an inlet 18. The fluid is supplied to the liquid cannon 10 via the inlet 18.

The nozzle 16 is arranged to rotate about a first axis A-A (which can be called a ‘luff’ axis) accommodating vertical angular movement of the nozzle 16 within the body 13 of the head assembly 12. Preferably, the nozzle 16 is arranged to rotate within a channel 17 of the body 13. The body 13 can house control, drive and/or power components, such as at least one electric motor, gearing/belt drive components, control electronics etc. The body 13 can include a removable cover 11, such as for providing a field of view for sensors (such as lidar, radar, thermal, imaging/camera, electromagnetic, acoustic or Doppler) and/or access to such components as control, drive and/or power components.

The head assembly 12 is preferably mounted for rotation about a second axis B-B (which can be called a ‘slew’ or ‘yaw’ axis) to accommodate rotation of the head assembly 12 relative to the tail assembly 14.

The head assembly 12 can rotate/slew up to, including and beyond 360° relative to a mount 21.

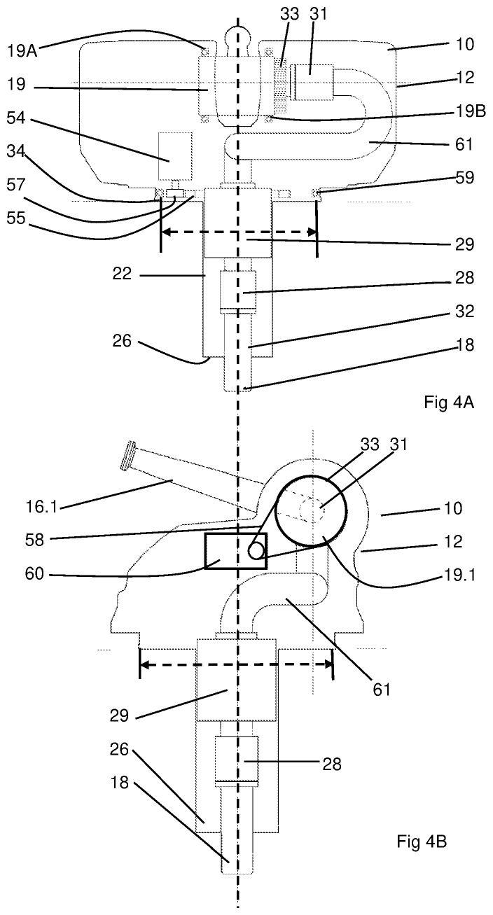

The head assembly 12 may be mounted for rotation to a mount 20. The mount 20 may include a plate arrangement 21 for attachment of the tail assembly 14 (and therefore the mounted head assembly) to a fixed installation 44, such as a wall of a transfer chute (see FIG. 6).

The nozzle 16 may be attached to a rotatable conduit portion 19. The rotatable conduit portion 19 provides part of a fluid pathway from the inlet 18 to the nozzle 16 for water to flow through the liquid cannon 10.

The tail assembly 14 includes a sleeve 22. The sleeve 22 houses and protects therein part of the conduit from the inlet and any electrical and/or other power supply connections (such as hydraulic or pneumatic connections) and/or other necessary components.

The inlet 18 can be connected to a lower end 26 of the sleeve 22. A rotary coupling/union 28 connects the inlet 18 to a conduit portion 32.

A rotary electrical connection 29 (such as a slip ring) enables electrical connection to be maintained for power, control and/or data electrical supply between the head and tail assemblies (12, 14) for rotation of the turret and elevation/declination of the nozzle 16.

A conduit mount 30 (such as a flange) can be attached to the lower end 26 of the sleeve 22. The rotary coupling 28 enables relative rotation of the conduit portion 32 with respect to the sleeve 22 (and therefore the head assembly 12 relative to the tail assembly 14) during rotation of the head assembly 12.

The rotary coupling or union 28, 31 includes at least one seal (not shown) preventing liquid/water leakage.

The mount 20 of the tail assembly 14 preferably includes a turret ring/bearing 34. The turret ring/bearing 34 can attach (such as by bolting) to the plate arrangement 21. The turret ring/bearing 34 may be referred to as a slew bearing.

The turret ring (or slew bearing) preferably forms the primary load path for forces that act upon the head of the turret to the tail assembly, and in turn the structure to which the liquid cannon 10 is fixed too. Removing the primary load path away from the rotary union.

A controller 36 can be provided, such as mounted to the tail assembly 14. However, the position of the controller can be varied to suit applications of the liquid cannon 10.

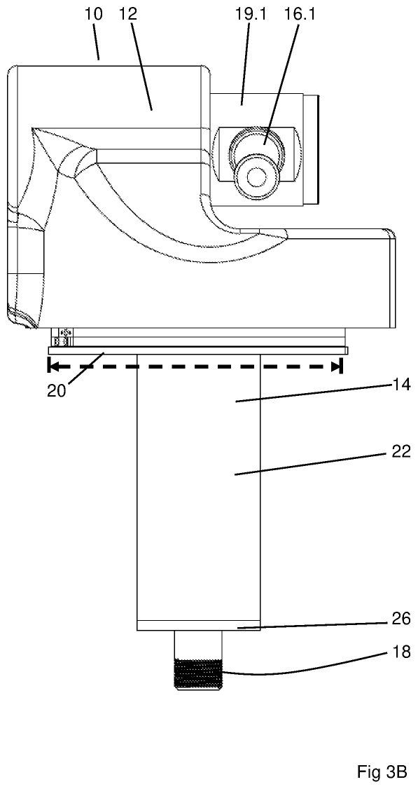

Relative to a plane (P), the luff arc (A_{L}) of the nozzle 16 may be from a forward pointing, downward angled (Forward Downward (FD)) position to a rearward downward angled (Rearward Downward (RD)) position, transiting in an arc through upright/vertical (V), as represented in FIG. 5.

It will be appreciated that the overall luff angle of arc A_{L} can be over 200°.

Providing a depression angle (below level) for the nozzle 16 front and/or rearwards, reduces the size of zone that the liquid cannon 10 cannot otherwise direct liquid to.

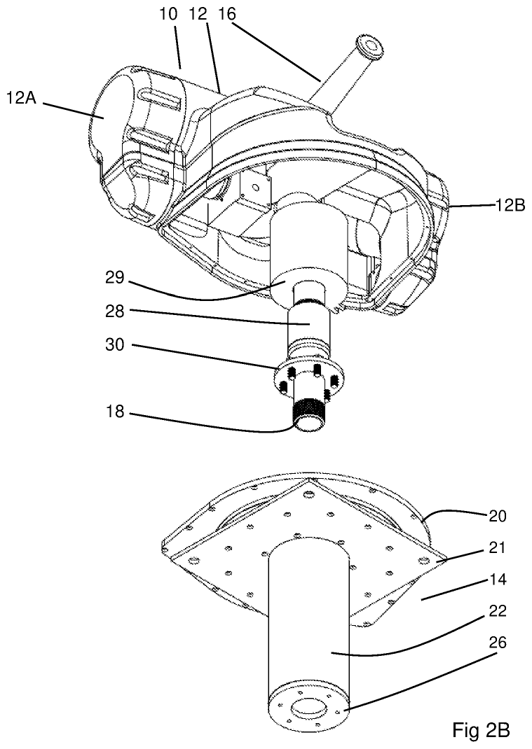

As shown by way of non-limiting example in FIGS. 3A and 3B, the liquid cannon 10 can include a rotatable conduit 19 that is supported by the body 13 on a single side of the nozzle 16.1. The rotatable conduit 19 can provide liquid entry on a single side of the nozzle 16.1. The liquid cannon 10 can have a single-sided rotatable conduit portion 19.1 mounted at one side for rotation and liquid inlet to the nozzle 16.1. The other side is closed.

Slew or rotation drive can be by a drive means 54. In some embodiments, the drive means 54 comprises an electric drive (e.g. one or more electric motors). In some embodiments, the drive means 54 comprises a pneumatic drive. In some embodiments, the drive means 54 comprises a hydraulic drive (e.g. one or more hydraulic motors). In some embodiments, the liquid cannon 10 uses the feed fluid to enable rotation.

The drive means 54 can be operably connected to a drive gear 55 via a pinion gear 57. The turret/body can be mounted via bearing 59 for slew/rotation.

In some embodiments, the drive means 54 can be operatively connected to a worm wheel that is driven by a worm. In some embodiments, the drive means 54 can be operatively connected to a belt system/drive. In some embodiments, use of the drive means 54 uses a reaction force provided by the application of hydraulic fluid power. In some embodiments, the drive means 54 comprises a plurality of the systems and/or components described herein.

The rotatable conduit portion can be mounted by bearings 19A, 19B at either end or by one or more bearings at one end thereof for the single ended version (FIGS. 3A and 3B).

Drive to the rotatable conduit portion can be by belt drive 58 powered by a motor 60 to a drive pulley 33. Direct drive or drive through one or more gears is also envisaged.

A conduit 61 provides a flowpath to the rotatable conduit portion and to the nozzle 16. The rotatable conduit portion 19 can be connected to the conduit 61 within the turret by a rotary union (e.g. a luff rotary union). The rotary union 31 maintains a liquid tight seal between the conduit 61 and the rotatable conduit portion 19 allowing rotation (luff) of the rotatable conduit portion 19 to which the nozzle 16 is connected.

FIG. 6 shows an embodiment of a liquid cannon 10 provided within a transfer chute 38. The transfer chute 38 transfers material from a conveyor 42 from one direction, such as from the right in FIG. 6, to a second conveyor (not shown) for conveying in an alternative direction (typically at right angle to the incoming conveyor). A hood 40 maintains a coherent flow of material from the incoming conveyor and helps to reduce dust. A ‘spoon’ 70 guides the transferred material onto the second conveyor and helps to reduce dust.

The liquid cannon 10 can be mounted to a wall 44 within the transfer chute 38. For installation, the tail assembly 14 can be inserted into a hole from the transfer chute interior side of the wall 44.

The turret/body 13 is mounted for rotation relative to the tail assembly 14. The turret/body 13 attaches to the mount 20 which is attached to the chute 38 via plate 21. Mount 20 rotates relative to the plate 21.

Turret rotation and nozzle luff provide two degrees of freedom for the nozzle 16 to direct the liquid into a three-dimensional arc space within the interior of the transfer chute 38.

The liquid cannon 10 may be mounted to support 46, 52, 56, such as a pedestal or block or bracket. The liquid cannon 10 may be mounted to a chassis for mobility, such as a vehicle or trailer chassis.

A pedestal 46 type mount may have access 48 and a lifting point 50, such as for a forklift tine.

The support (such as a pedestal) may be of concrete, steel, or a combination thereof or other suitably strong material to support the weight of the liquid cannon, any ancillary equipment and forces arising from projecting the liquid from the cannon.

The liquid cannon 10 may be elevated, such as mounted to a bracket 56 or beam. The bracket 56 or beam may be supported by an upright 58 or other fixed installation, such as a wall. The liquid cannon 10 may be boom mounted for manoeuvrability.

One or more forms of the present invention can include a liquid cannon 10 pre-mounted to an adapter plate 62, with the head assembly 12 of the liquid cannon 10 to pass through an aperture 64 in a wall 66 and the adapter plate 62 to mount to the wall 66 (such as by bolting or welding), according to a further embodiment of the present invention.

The head assembly 12 and the tail assembly 14 can be mounted with the adapter plate 62 therebetween.

The aforementioned arrangement can be provided to suit certain applications where access to one side of the wall is restricted or limited (such as for limited space or personnel safety), and the liquid cannon 10 can therefore be mounted from the reverse side of the wall by use of the adapter plate and a larger aperture in the wall than would otherwise be used for just the head and tail assembly mounting arrangement without the adapter plate.

A reaction force applied to the head assembly 12 of the liquid cannon 10 when discharging liquid can transfer to the tail assembly 14 of the liquid cannon 10 and in turn to the structure it is mounted to.

The turret ring (or slew bearing) 59 preferably provides a primary load path for reaction forces (F_{R}) that act upon the head assembly 12 to the tail assembly 14 and in turn the structure (such as a wall, chute, pedestal, bracket etc.) to which the liquid cannon is fixed too. Such an arrangement moves the primary load path away from the rotary union 28 and puts the reaction forces through the turret ring/slew gear/slew bearing 55 to the tail assembly and into the mount/wall/fixed installation.

The rotatable conduit portion 19 can include bearings 19A, 19B to react forces (Fᵣ) from the action forces (Fₐ) from discharging liquid through the nozzle.

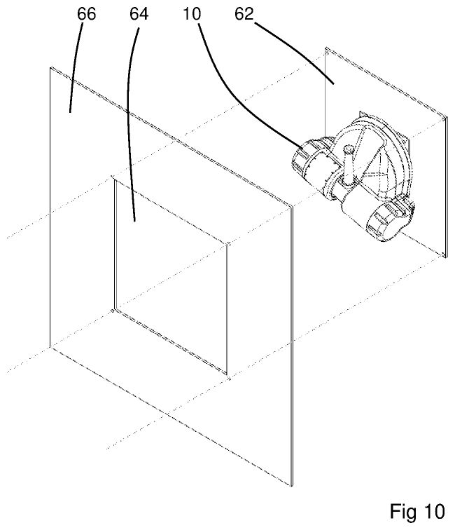

The body or turret 13 of the head assembly 12 can include multiple nozzles 16, such as shown in FIGS. 12A and 12B by way of example.

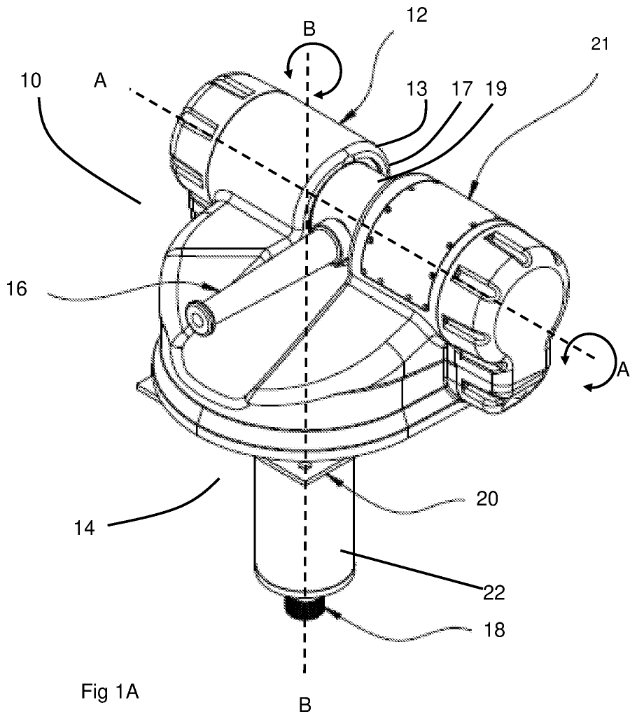

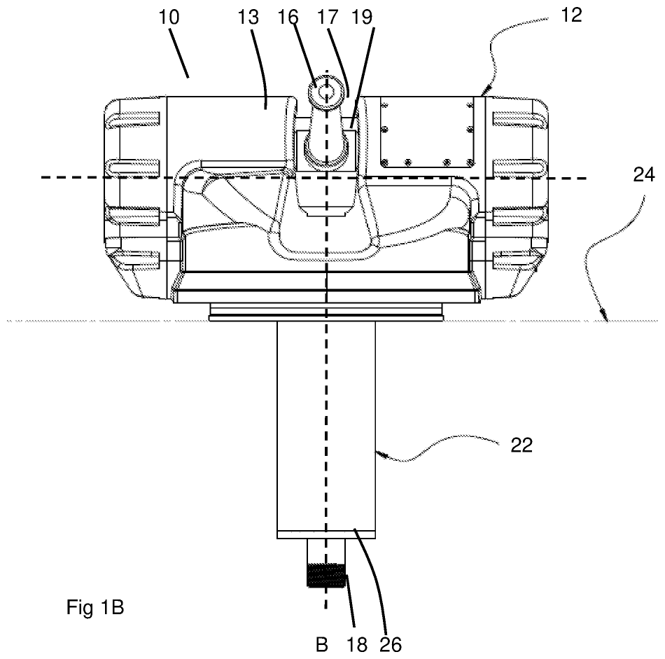

One or more of the nozzles 16 can be mounted for rotary motion with respect to the body/turret 13 (as shown in FIGS. 12A and 12B) or can be mounted for luff motion (such as in FIG. 1A or 3A).

It will be appreciated that a combination of slew motion/positioning of the body/turret and luffing or rotation of the nozzle(s) can be controlled to direct the required jet of the liquid in a desired direction or at a desired target.

Positioning control can be provided by remote control, onboard control or a combination thereof. Sensing, such as visualisation using one or more cameras, can be provided onboard, such as through a window 68.

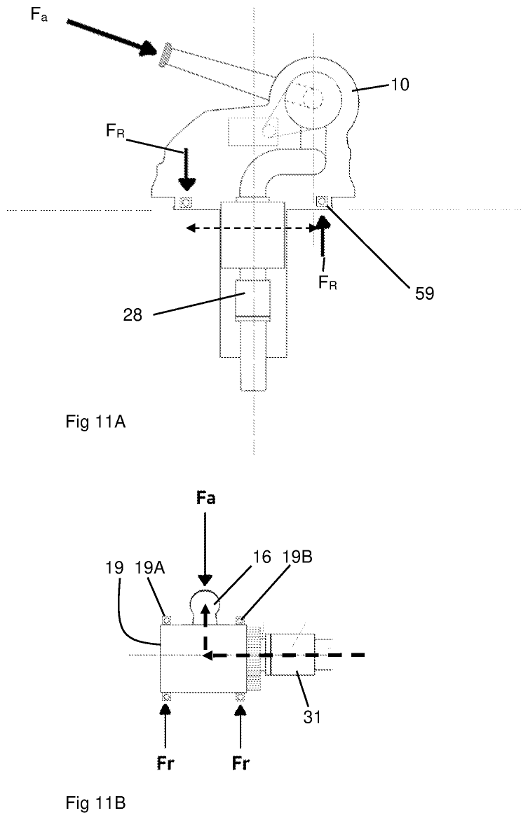

FIG. 13 is a side view of an embodiment the liquid cannon 10. The liquid cannon 10 is shown in a retracted state, with the nozzle 16 withdrawn.

When disposed on the side of a structure (e.g. the transfer chute 38), process material can accumulate on an upper portion of the liquid cannon 10. The accumulated material may form an angle of repose 80 (which is influenced by gravity and the extent to which the liquid cannon 10 projects from the side of the structure). The angle of repose 80 is transverse to a mating plane between the liquid cannon 10 and the structure.

Once sufficient material has accumulated on the liquid cannon 10 to form the angle of repose, new material is inhibited from accumulating on the liquid cannon 10. As shown in FIG. 13, process material 82 moves with a trajectory 84. The process material contacts accumulated material 86. The accumulated material 86 is process material that is supported by the upper portion of the liquid cannon 10. Due to the angle of repose, the additional process material 82 is not able to be stability supported by the accumulated material 86, and follows a second trajectory 88, away from the liquid cannon 10.

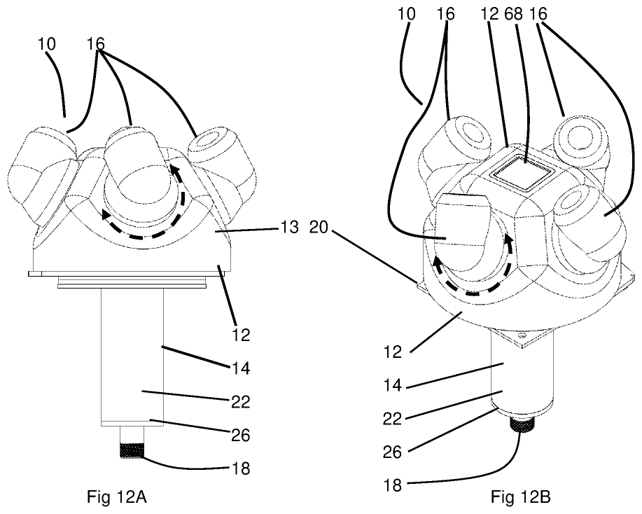

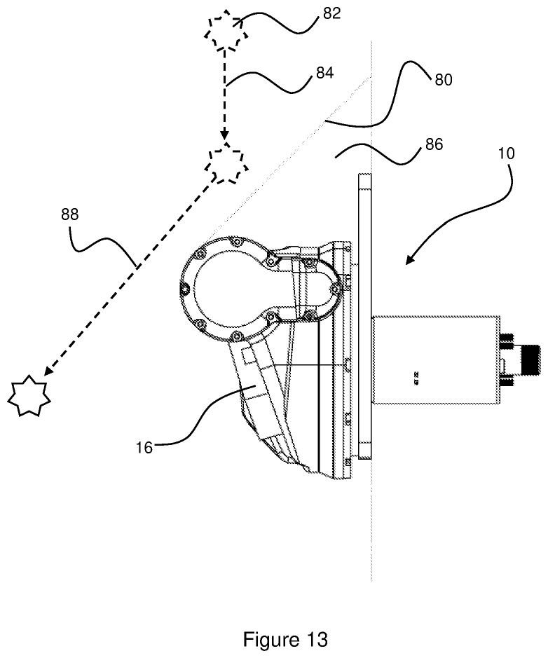

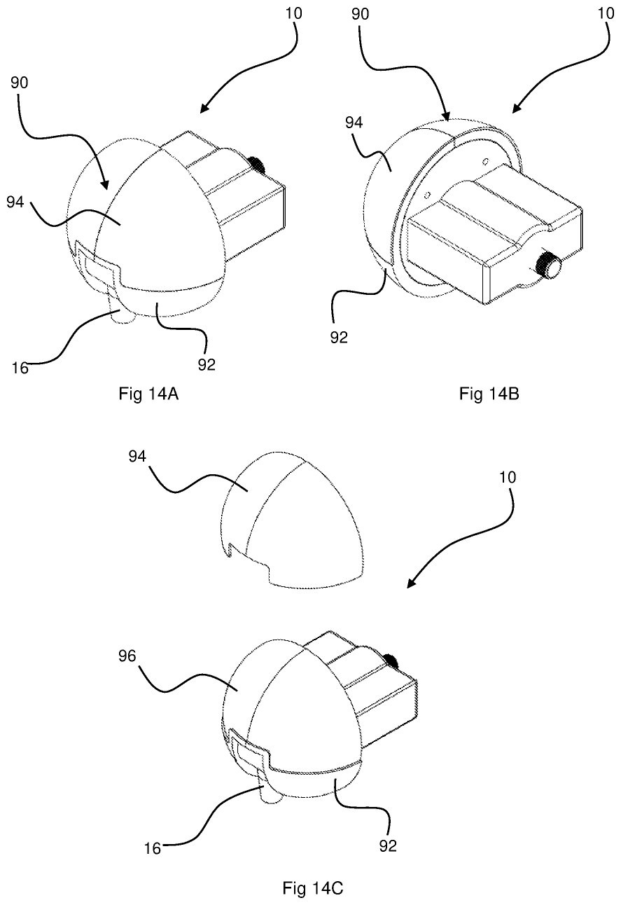

FIGS. 14A-14C show an embodiment of the liquid cannon 10. The liquid cannon 10 of FIGS. 14A-14C comprises a shell 90. In particular, the body 13 may comprise the shell 90. The shell 90 may be removably connected to the body 13. The shell 90 may be referred to as a protective shell. The shell 90 may be referred to as a cover. The shell 90 may be referred to as a protective cover. The shell 90 may comprise a first shell portion 92. The first shell portion 92 defines a wall that covers one or more portions of the liquid cannon 10. For example, the first shell portion 92 covers one or more other portions of the body 13. The shell 90 may comprise one or more subsequent shell portions 94.

The subsequent shell portion(s) 94 may be removably connected to a portion of the shell 90. In some embodiments, the subsequent shell portion(s) 94 may be connected to an initial portion of the shell 90. In some embodiments, the subsequent shell portion(s) 94 may be connected to an upper portion of the shell 90. In some embodiments, the body 13 comprises a recessed portion 96. In particular, the shell 90 comprises the recessed portion 96. The recessed portion 96 is configured to at least partially receive one or more of the subsequent shell portions 94. The shell 90 may be referred to as a surface liner. The surface liner may be a consumable component.

As described herein, process material can contact the liquid cannon 10. The process material may act to abrade one or more surfaces of the liquid cannon 10. The surface liner acts to protect the shell 90 and/or other aspects of the liquid cannon 10 and can be replaced when damaged and/or worn.

The shell 90 may comprise one or more of a polymer, metal, plastic, rubber, ceramic or composite material. In particular, the first shell portion 92 may comprise one or more of a polymeric, organic, fibrous, metallic, plastic, rubber, ceramic and composite material. One or more of the subsequent shell portions 94 may also comprise one or more of a polymeric, metallic, plastic, rubber, ceramic and composite material. The metal may preferably include an impact or abrasion resistant metal matrix composite.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-30. (canceled)

31. A liquid cannon for use in discharging a liquid, the liquid cannon comprising:
a head assembly, a tail assembly, an inlet for the liquid, and a conduit;
wherein:
the head assembly comprises:
a body and a plate connected together to define at least part of a head assembly compartment;
a nozzle;
a rotatable conduit portion bearing;
an access opening; and
a cap configured to connect to the body to cap the access opening;
the conduit comprises a rotatable conduit portion that is fluidly connected to the nozzle and operably connected to the rotatable conduit portion bearing such that the rotatable conduit portion is rotatable about a first axis of the rotatable conduit portion bearing, thereby accommodating vertical angular movement of the nozzle;
the conduit extends through the rotatable conduit portion bearing in a direction that is parallel to the first axis;
the first axis passes through the access opening;
the head assembly is mounted to a bearing;
the tail assembly comprises a sleeve defining at least part of a tail assembly compartment, and a mounting portion;
the mounting portion is configured to be mounted to the bearing such that the head assembly is rotatable with respect to the tail assembly at the bearing;
the mounting portion is disposed between the sleeve and the body;
the mounting portion is configured to enable the liquid cannon to be mounted to a structure;
the conduit provides a flowpath for the liquid between the inlet and the nozzle;
the conduit passes through the sleeve of the tail assembly, the bearing and the head assembly;
the head assembly compartment is sealed from an environment of the liquid cannon;
the tail assembly compartment is sealed from the environment of the liquid cannon; and
at least one of the head assembly compartment and the tail assembly compartment houses a controller that is configured to control a drive means of the liquid cannon to drive movement of the nozzle.

32. The liquid cannon of claim 31, wherein at least a portion of the conduit is arranged and configured to rotate relative to the mounting portion.

33. The liquid cannon of claim 31, wherein the bearing provides a load path between the head assembly and the mounting portion.

34. The liquid cannon of claim 31, wherein one or more dynamic seals are present concentric with the axis of the bearing.

35. The liquid cannon of claim 31, wherein the inlet is attached to the mount and a second rotary coupling bearing permits rotation of the conduit and the head assembly relative to the inlet.

36. The liquid cannon of claim 31, wherein a rotary electrical connector provides continuity of electrical connection between the head assembly and the tail assembly, wherein the conduit passes through the rotary electrical connector.

37. The liquid cannon of claim 31, wherein:
the nozzle is mounted by a pivot connection enabling the vertical angular movement of the nozzle; and
liquid to the nozzle flows through the pivot connection.

38. The liquid cannon of claim 37, wherein the pivot connection comprises a rotatable conduit portion bearing.

39. The liquid cannon of claim 38, wherein the rotatable conduit portion bearing forms a load path for forces between the nozzle and the body.

40. The liquid cannon of claim 39, wherein the pivot connection further comprises one or more dynamic seals.

41. The liquid cannon of claim 31, wherein when the mounting portion is mounted to the structure, the sleeve and a portion of the conduit is configured to penetrate the structure.

42. The liquid cannon of claim 31, the head assembly including at least one sensor housed therein.

43. The liquid cannon of claim 42, wherein the at least one sensor includes at least one of pressure, rotary encoder, temperature, lidar, radar, thermal sensing, imaging, Doppler, GPS, rotational orientation of the head assembly and/or nozzle, or any combination of two or more thereof.

44. The liquid cannon of claim 31, wherein rotation of the head assembly at the bearing is driven by an arrangement including a driven pinion gear engaging with a ring gear or by a worm drive or by a belt drive or by direct fluid power.

45. The liquid cannon of claim 37, including electrical, mechanical, pneumatic or hydraulic drive means to actuate vertical angular movement of the nozzle and/or rotation of the head assembly.

46. The liquid cannon of claim 31, wherein the liquid cannon is mountable to a transfer chute such that liquid discharged from the nozzle is directed within an interior space of the transfer chute wherein the tail assembly projects through a portion, such as a wall, of the transfer chute.

47. The liquid cannon of claim 31, wherein the nozzle is mounted for vertical angular movement to the body by a bearing arrangement laterally positioned with respect to one side of the nozzle or is mounted for vertical angular movement by bearing arrangements laterally positioned with respect to both sides of the nozzle.

48. A liquid cannon for use in discharging a liquid, the liquid cannon having an inlet for the liquid and a conduit providing a flowpath for the liquid between the inlet and at least one nozzle, the conduit coupled between the nozzle and inlet about at least one rotary coupling, the liquid cannon including a head assembly having a body supporting the at least one nozzle, and a mount for supporting the head assembly, a bearing disposed between the head assembly and the mount for rotationally supporting the head assembly relative to the mount, the conduit being configured to pass through the bearing, and wherein the bearing being configured to form a primary load path for forces that act upon the head assembly to the mount so as to remove the primary load path away from a first one of the at least one rotary coupling.

49. The liquid canon of claim 48, wherein the at least one nozzle is able to move with at least two degrees of freedom and the conduit being coupled between the nozzle and inlet about a plurality of the rotary couplings, the at least two degrees of freedom including slew rotation at the bearing disposed between the head assembly and the mount; and luff rotation by movement of the at least one nozzle relative to the to the body of the head assembly, the luff rotation being through a bearing arrangement laterally positioned with respect to at least one side of the nozzle, the bearing arrangement being configured to form a primary load path for forces that act upon the nozzle to the body of the head assembly so as to remove the primary load path away from a second one of the plurality of rotary couplings.

50. A liquid cannon for use in discharging a liquid, the liquid cannon comprising:
a head assembly comprising a body and a nozzle, a tail assembly configured to mount the liquid cannon to a structure, an inlet for the liquid, and a conduit providing a flow path for the liquid between the inlet and the nozzle;
wherein:
the head assembly is mounted to a bearing;
the tail assembly comprises a sleeve defining a mounting portion;
the mounting portion configured to be mounted to the bearing such that the head assembly is rotatable with respect to the tail assembly at the bearing; and wherein the mounting portion is configured to enable the liquid cannon to be mounted to the structure such that the head assembly is locatable in an interior space of the structure and the tail assembly protrudes outside of the interior space of the structure for reducing the head space required for the liquid cannon within the interior space of the structure.
